(19) United States
(12) Patent Application Publication
(10) Pub. No.: US 2015/0377777 A1
(43) Pub. Date: Dec. 31, 2015

(54) DUAL STRUCTURED ILLUMINATION MODULATED IN PHASE AND INTENSITY

(71) Applicant: OPTICS 3D Ltd., Haifa (IL)

(72) Inventor: Meir BEN-LEVY, Haifa (IL)

(21) Appl. No.: 14/447,639

(22) Filed: Jul. 31, 2014

Related U.S. Application Data
(60) Provisional application No. 62/018,613, filed on Jun. 29, 2014.

(51) Int. Cl. G01N 21/41; G01N 21/65

(52) U.S. Cl. CPC G01N 21/41; G01N 21/65; G01N 2201/12; G01N 2201/068

(57) ABSTRACT

A method and apparatus for imaging a live cell object, the method including the steps of: (a) modulating the phase of an electromagnetic wave in a periodic pattern with a two dimensional phase grating to produce a phase modulated electromagnetic wave in two axes; (b) projecting a real image of the phase grating onto an object to produce phase modulated electromagnetic wave illumination of the object; (c) varying a location of the periodic pattern in time along the two axes to change the phase of the periodic pattern; (d) projecting a real image of the object to a detector; (e) recording multiple images of the object with the detector, each of the images is recorded with the periodic pattern in a different location; and (f) calculating a synthetic image of the object by extracting information 90 degrees out of phase with the illumination.

This patent application claims priority from and the benefit of U.S. Provisional Patent Application No. 62/018,613, filed Jun. 29, 2014

### FIELD AND BACKGROUND OF THE INVENTION

The present invention relates to a 3D imaging and, more particularly, to a three dimensional (3D) imaging of phase shifting objects, capable of creating phase shifts due to the refraction index variations within the object. In one embodiment, the invention relates to live cells imaging. Traditionally, live cells are imaged in two Dimensions (2D) with phase contrast microscopy techniques invented by Frits Zernike (Ref. 1), who won the Nobel Prize in physics 1953 “for his demonstration of the phase contrast method, especially for his invention of the phase contrast microscope”. The phase contrast microscope enhances contrasts of transparent and colorless objects by influencing the optical path of light in a manner that transforms the diffraction of light by phase shift objects into intensity variations (contrast) at the image plane, thereby allowing a sensor, camera or the human eye to image/perceive those phase shifts. The phase contrast microscope is able to show components in a cell or bacteria characterized by the slightly different refraction index of each component, that otherwise would be very difficult to see without additional chemical color dyes, which are lethal to live cells.

Shortly after Zernike won the Nobel price, in 1960 Georges Nomarski patented (Ref. 2) what is known today as Differential Interference Contrast (DIG) microscopy merely giving the world another technology capable of detecting phase shifting objects.

More accurate measurements of phase shifts can be obtained by digital holography, a technology known also as quantitative phase imaging such as US20140085715 (Ref. 10 see also references 8-9 and 11). In digital holography, a plane wave, commonly known as an ‘object beam’ passes through the phase object (hence the term object beam), and interferes with another plane wave called ‘reference beam’, to form an interferometric pattern known as interferogram. The phase distortion of the object beam, resulting from phase shifts of the object, can now be analyzed and measured from the interferogram.

Modern live cell imaging commonly uses confocal microscopes with the assistance of fluorescent labels. The confocal microscope was invented by Marvin Minsky (Ref. 3) in 1957, and is widely used in 3D imaging of biological objects including live cells. Confocal microscopy is an optical imaging technique using point illumination, typically of laser source but may also use Hg arc lamps and a spatial pinhole to eliminate out light in specimens. As a result, the confocal microscope is able to image, in 2D, a thin layer within the depth of focus which in turn enables the reconstruction of a 3D image from the multiple thin layers.

Unlike phase contrast, the confocal microscope cannot image phase shifts, and the ability to image live cells is limited to the use of fluorescent labeling. The aforementioned limitation is not necessarily a disadvantage, as fluorescent labels and biomarkers can provide important information that could not otherwise be obtained. For example, implementing Fluorescent Resonance Energy Transfer (FRET), a technology that indicates interaction between two molecules tagged/labeled with different fluorophores, can give highly valued information of the chemical reactions that occur as part of the live cell activity. However, there is also disadvantage of fluorescence in conjunction with live cell imaging that downgrades the performance of confocal microscopy, known as phototoxity (Ref. 4). Though the chemicals used for fluorescence are not toxic by themselves, when illuminated with an electromagnetic wave, the electrons are excited to high energy levels and become chemically active so as to form reagents such as singlet oxygen (¹O₂), super oxide (O₂⁻) or hydroxyl radical (HO⁻). All of the aforementioned reagents are toxic and may affect the activity of—or completely destroy—the live cell. Other methods that can be used in place of fluorescence are Raman scattering and luminescence, though the use of these techniques is rare.

Structured illumination is an optical technique that uses patterned illumination intensity to image a thin slice of biological substance and can provide 3D imaging similar to confocal microscopy (Ref. 5). Structured illumination has a resolution advantage over confocal microscopy known as super resolution, which provides the capability to improve the lateral resolution twice as high, compared to the diffraction limits of confocal or standard incoherent microscopes. Super resolution was invented by Lukosz and Marchand in 1963 (see Ref. 6) with static pattern of illumination. A static pattern means that some points of the object receive low light intensity, according to the pattern, therefore the resulting image tends to be noisy at these points.

A solution to this problem, introduced in 1995 by U.S. Pat. No. 5,867,604 (Ref. 7) to the same author, is to vary the phase of the pattern in time, so all points of the objects are illuminated in different time with the same intensity. U.S. Pat. No. 5,867,604, which is incorporated by reference as if fully set forth herein, discloses an optical imaging system such as a microscope, wherein the object is illuminated with a periodic pattern of illumination intensity in one or two axes x and y and the phase of the pattern varies in time. According to the teaching of U.S. Pat. No. 5,867,604, the output signal S of a detector at the image plane can be analyzed to produce a signal S₁, which is the component of S that varies in phase with the illumination and a signal S₂, which is the component of S that varies 90 degrees out of phase with the illumination. U.S. Pat. No. 5,867,604 further introduces a mathematical analysis proving that the in-phase signal S₁ is related to the object as an image, with extended resolution (super resolution) that can be extended twice as high as the diffraction limitation of the optical imaging system. The analysis further proves that a 90 degrees out of phase signal S₂ is related to the object as a Hilbert-transformed image and also provides extended resolution.

### SUMMARY OF THE INVENTION

The present invention provides 3D and thin slice imaging that can be performed completely or partially without fluorescence, by imaging phase shifts within the live cells. Furthermore such phase shift imaging can be coupled to fluorescent imaging techniques such as FRET, in a way that both images will carry information measured at the same or close slice.

The Hilbert Transform image does not provide significant information when imaging reflection, transmission or fluorescence, creating no motivation to analyze such an image in structured illumination microscopy. According to the present invention, the Hilbert transform is used as an ideal method to resolve phase shifting objects because such objects tend to create a discontinuity of refraction index at the edges and the Hilbert Transform enhances such lines of discontinuity within the object. Since, however, neither a Confocal nor Structured Illumination microscope is sensitive enough to image phase shifting accurately, the present invention describes a microscope design capable of extracting the Hilbert Transform Image like S₂ of U.S. Pat. No. 5,867,604 and is furthermore sensitive to phase shifting objects.

According to the present invention there is provided an imaging apparatus for imaging objects, including: (a) an object plane and an image plane; (b) a first grating, the first grating being an intensity grating adapted to modulate the intensity of an electromagnetic wave in a periodic pattern, forming an intensity modulated electromagnetic wave; (c) a first optical imaging system, the first optical imaging system adapted to project a first real image of light of the intensity modulated electromagnetic wave at the first grating to the object plane; (d) a second grating, the second grating being a two dimensional phase grating adapted to modulate the phase of an electromagnetic wave in a periodic pattern, forming a phase modulated electromagnetic wave; (e) a second optical imaging system, the second optical imaging system adapted to project a second real image of light of the phase modulated electromagnetic wave at the second grating to the object plane, in a direction opposite to a direction of the light projected by the first optical imaging system; (f) a third optical imaging system adapted to image light at the object plane to the image plane, the third optical imaging system adapted to image light traveling backwards from an object located at the object plane when illuminated by the first optical imaging system and light transmitted through the object when illuminated by the second optical imaging system; (g) a sensor located at the image plane, the sensor adapted to capture the light imaged by the third optical imaging system; and (h) a processor coupled to the sensor, the processor configured to calculate a first synthetic image of the object interacting with the electromagnetic wave projected by the first optical imaging system; and the processor further configured to calculate a second synthetic image of the object interacting in phase shifts with the electromagnetic wave projected by the second optical imaging system at the object.

According to further features in preferred embodiments of the invention described below the processor is further configured to combine the first synthetic image and the second synthetic image to obtain images of electromagnetic phase shifting by the object and electromagnetic interactions other than phase shifting with the object.

According to still further features in the described preferred embodiments the processor is further configured to combine the first synthetic image and the second synthetic image to obtain images of florescence labels and phase shifting of the object.

According to still further features the processor is further configured to combine the first synthetic image and the second synthetic image to obtain images of luminescent labels and phase shifting objects.

According to still further features the processor is further configured to combine the first synthetic image and the second synthetic image to obtain images of Raman scattering and phase shifting objects.

According to still further features the processor is further configured to calculate a third synthetic image by extracting a signal 90 degrees out of phase with the intensity modulated electromagnetic wave.

According to still further features the periodic pattern of the first grating is displaced in time to vary a pattern phase and the periodic pattern of the second grating is displaced in time to vary a pattern phase.

According to still further features the periodic pattern of the first grating and the period pattern of the second grating are displaced by a single actuator.

According to still further features the calculation of the first synthetic image is executed by extracting a signal in phase with the intensity modulated electromagnetic wave and the calculation of the second synthetic image is executed by extracting a signal 90 degrees out of phase with the phase modulated electromagnetic wave.

According to another embodiment there is provided a method for imaging a live cell object, the method including the steps of: (a) modulating the phase of an electromagnetic wave in a periodic pattern with a two dimensional phase grating to produce a phase modulated electromagnetic wave in two axes; (b) projecting a real image of the phase grating onto an object to produce phase modulated electromagnetic wave illumination of the object; (c) varying a location of the periodic pattern in time along the two axes to change the phase of the periodic pattern; (d) projecting a real image of the object to a detector; (e) recording multiple images of the object with the detector, each of the images is recorded with the periodic pattern is a different location; and (f) calculating a synthetic image of the object by extracting information 90 degrees out of phase with the illumination.

The present invention overcomes the limitations of the prior art by providing Phase Structured Illumination, which is a novel imaging system that illuminates an object with an electromagnetic wave characterized by amplitude and phase, where the phase of the wave is structured in a periodic pattern in two axes. A mathematical analysis is provided herein proving that the Hilbert Transform image of phase shifting objects can be extracted when applying Phase Structured Illumination. The invention further discloses methods and apparatuses for coupling Intensity Structured Illumination with Phase Structured Illumination in order to obtain images of both fluorescent labels and phase shifting objects.

### BRIEF DESCRIPTION OF THE DRAWINGS

Various embodiments are herein described, by way of example only, with reference to the accompanying drawings, wherein:

FIG. 1 is a high level block diagram of an imaging apparatus of the present invention;

FIG. 2 is a layout diagram of an imaging apparatus according to an embodiment of the present invention;

FIG. 3a-3d are various Transfer Functions.

### DESCRIPTION OF THE PREFERRED EMBODIMENTS

The principles and operation the present invention may be better understood with reference to the drawings and the accompanying description.

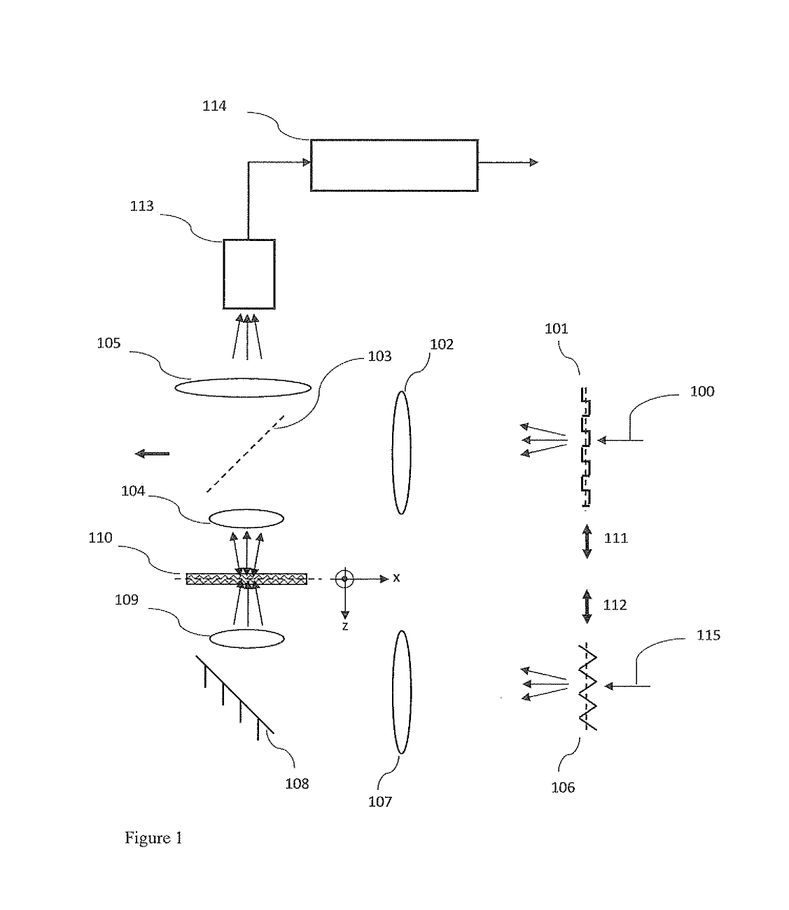

Referring now to the drawings, FIG. 1 illustrates a high level block diagram of an optical setup of an imaging apparatus of the present invention. A first electromagnetic wave 100 is modulated by a first grating, which is an intensity grating 101 in a periodic pattern of light intensity. The term ‘intensity grating’ is used for—and interchangeably with—any optical element, such as an amplitude grating, a Liquid Crystal Display (LCD) or a Digital Light Processor (DLP), that can modulate the intensity of light. The intensity modulated electromagnetic wave is projected by a first optical imaging system 102/104 on to an Object 110 through a beam-splitting component such as a beam splitter 103, or a dichroic mirror. That is to say that the first optical imaging system projects a first real image of the intensity modulated electromagnetic wave at the first grating to an object plane, where the object (e.g a live cell or cells) is located. The illumination intensity Lₘₙ at the Object plane, when illuminated by first electromagnetic wave, can be written as:

Lₘₙ(x,y)=A₀+A₁ cos(2πx/δₓ+2/πm/M)cos(2πy/δ_{y}+2πn/N)+HH (1)

where the intensity function Lₘₙ is periodic in x and y with periods of distances δₓ, δ_{y}. The integers m=1 . . . M and n=1 . . . N relate to the phase of the pattern which can be shifted in time, for example by moving the intensity grating or electrically moving the pattern created on LCD or DLP, generally represented by bidirectional arrow 111. The HH stands for higher harmonics of δₓ, δ_{y}, which may modulate the intensity. Equation (1) can also describe one dimensional grating if, for example M=1 and δₓ→∞.

A third optical imaging system 104/105 images light at the object plane to an image plane at a sensor 113. The sensor/detector can be for example a camera, a CCD camera or any type of detector that can grab an image. The third optical imaging system 104/105 images the light reflected back/returned [backwards]/travelling backwards from object 110 (by fluorescence, scattering, luminescence or any other manner) to sensor 113 which is coupled to a processor 114. The light travels back from object 110 when illuminated by the first optical imaging system. Sensor 113 captures M×N images Iₘₙ(x,y), while the phase of the intensity grating is varied. A first synthetic image of the object S₁, interacting with the electromagnetic wave projected by the first optical imaging system, can be calculated by the processor 114 according to the teachings of U.S. Pat. No. 5,867,604, by extracting the signal in phase with the illumination (i.e. the intensity modulated electromagnetic wave illuminating the object), using the transformation:

$${S}_{1} ( x , y ) = {\sum }_{m = 1}^{M} {\sum }_{n = 1}^{N} {I}_{mn} ( x , y ) cos ( 2 π x \text{/} {δ}_{x} + 2 π m \text{/} M ) cos ( 2 π y \text{/} {δ}_{y} + 2 π n \text{/} N ) \qquad ( 2 )$$

A Hilbert Transformed, third synthetic image of the object S₂ can be calculated according to the teaching of U.S. Pat. No. 5,867,604 by extracting the signal 90 degrees out of phase with the illumination (i.e. intensity modulated electromagnetic wave), using the transformation:

$${S}_{2} ( x , y ) = {\sum }_{m = 1}^{M} {\sum }_{n = 1}^{N} {I}_{mn} ( x , y ) sin ( 2 π x \text{/} {δ}_{x} + 2 π m \text{/} M ) sin ( 2 π y \text{/} {δ}_{y} + 2 π n \text{/} N ) \qquad ( 3 )$$

The modulation S can also be calculated:

S²=S₁²+S₂² (4)

The invention further discloses a second electromagnetic wave 115 modulated by a second grating, which is a phase grating 106 in a periodic pattern of wave-front phase. The term ‘phase grating’ is used to refer to—or interchangeably with—any optical element such as a phase diffraction grating, a Liquid Crystal in certain configurations (not LCD) or any other optical element that can modulate the phase of an electromagnetic light wave. The phase grating is a two-dimensional, phase grating which is able to modulate the phase of an electromagnetic wave in a periodic pattern, thereby forming a phase modulated electromagnetic wave. The periodic pattern of second grating can be displaced in time to vary a pattern phase. A second optical system 107, 108, 109 (for example, a tube lens, a folding mirror and an objective lens) can project a second real image of light of the phase modulated electromagnetic wave at the second/phase grating to the object plane. The direction that the second real image of light is projected is opposite to the direction in which the first real image of light was projected.

The first five grating orders of the phase modulated wave are projected by the second optical system 107-109 on the object plane to illuminate the object 110 with a wave function Ψₘₙ:

Ψₘₙ(x,y)=a₀₀σ(x,y)+a₁₁σ(x,y)exp[i(2πx/Λₓ+φ₀ₓ+2πm/M′+2πy/Λ_{y}+φ_{0y}+2πn/N′)]+a₁₋₁σ(x,y)exp[i(2πx/Λₓ+φ₀ₓ+2πm/M′−2πy/Λ_{y}−φ_{0y}−2πn/N′)]+a₁₁σ(x,y)exp[i(−2πx/Λₓ−φ₀ₓ−2πm/M′+2πy/Λ_{y}+φ_{0y}+2πn/N′)]+a₋₁₋₁σ(x,y)exp[i(−2πx/Λₓ−φ₀ₓ−2πm/M′−2πy/Λ_{y}−φ_{0y}−πn/N′)]

which can be summed to the form (see more details in the mathematical analysis):

Ψₘᵢₙ(x,y)=a₀σ(x,y)+i a₁σ(x,y)sin(2πx/Λₓ+φ₀ₓ+2πm/M′)sin(2πy/Λ_{y}+φ_{0y}+2πn/N′) (5a)

where i²=−I is the “complex imaginary unit”. The wave function Ψₘₙ illuminating the object has a periodic phase shift in x and y with periods of distances Λₓ, Λ_{y}. σ(x,y) is a wave function, related to the original wave 115 illuminating the phase grating and after projection through optical system 107/109. The integers m=1 . . . M′ and n=1 . . . N′ relate to the phase of the pattern which can be shifted in time, for example by moving the phase grating by a mechanical actuator such as piezoelectric actuator or electrically moving the pattern created on a Liquid Crystal, generally represented by bidirectional arrow 112. In one embodiment of the invention, a single mechanical actuator can move both the intensity and the phase grating. Equation 5a present a novel imaging system that illuminates the object with an electromagnetic wave characterized by amplitude and phase, where the phase of the wave is structured in a periodic pattern in two axes.

A beam of light transmitted through the object 110 is imaged by the third optical imaging system 104,105 to the sensor 113 coupled to processor 114. Sensor 113 captures M′×N′ images while the phase of the pattern of the phase grating 106 is varied (e.g. by a mechanical or electrical actuator). Now, a Hilbert Transformed, second synthetic image S′₂ of the phase shifts induced by the object interacting in phase shifts with the electromagnetic wave projected by the second optical imaging system, can be calculated according to the teachings of the invention as proven by novel analysis presented below, by extracting the signal 90 degrees out of phase with the illuminating wave pattern of equation Sa and using the transformation:

$${S}_{2}^{′} ( x , y ) = {\sum }_{m = 1}^{M} {\sum }_{n = 1}^{N} {I}_{mn} ( x , y ) cos ( 2 π x \text{/} {Λ}_{x} + {φ}_{0 x} + 2 π m \text{/} {M}^{′} ) cos ( 2 π y \text{/} {Λ}_{y} + {φ}_{0 y} + 2 π n \text{/} {N}^{′} ) \qquad ( 6 )$$

The images S₁ and S′₂ can be combined together to get the whole information of a live cell with labeling (by fluorescence, luminescence or other method) or Raman scattering imaged in S₁ and without labeling (by phase shifting) imaged in S′₂. Since labeling can be toxic to the live cell and since it is usually very specific to certain molecule and certain chemical process, the additional information given by S′₂ is valuable.

If required, the image of the phase shifts created by the object S′₁, can be calculated using the transformation:

$${S}_{1}^{′} ( x , y ) = {\sum }_{m = 1}^{M} {\sum }_{n = 1}^{N} {I}_{mn} ( x , y ) sin ( 2 π x \text{/} {Λ}_{x} + {φ}_{0 x} + 2 π m \text{/} {M}^{′} ) sin ( 2 π y \text{/} {Λ}_{y} + {φ}_{0 y} + 2 π n \text{/} {N}^{′} ) \qquad ( 6 a )$$

Where S′₁(x,y) is the signal in phase with the illuminating wave pattern of equation 5a.

The following novel analysis provides a mathematical proof to Hilbert transform imaging of phase shifting objects according to the teaching of the present invention. For simplicity, for better understanding and to avoid long mathematical formulation, the model will be given in one axis x. The extension to two axes x,y is simple following the same lines of the given analysis.

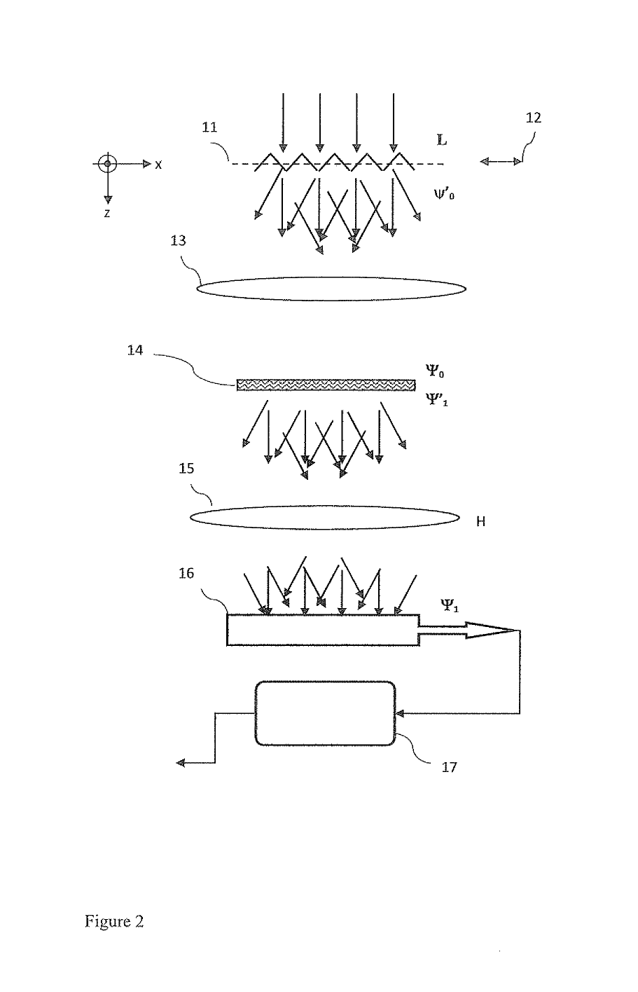

FIG. 2 depicts a layout diagram of an imaging apparatus according to an embodiment of the present invention. Assume an electromagnetic wave passes through a phase grating H (similar to the phase grating 106 of FIG. 1, but reduced to one axis only), and the first orders of the grating are projected on an object 14 by an optical imaging system 13. The pattern of the phase grating can be moved in a direction generally represented by bidirectional arrow 12. The object is now illuminated by an electromagnetic wave function Ψ₀ expressing the amplitude and phase of the wave and consists a periodic phase shifting with a basic period equal to Λ:

Ψ₀=σg₀+σg₁{exp[i(2πx/Λ+φₖ)]−exp[−i(2πx/Λ+φₖ)]} (7)

Where g₀, g₁ are real constants, i²=−1 and σ is a wave function appearing in both components of the summation, which indicates that both components are coherent to one another. The phase φₖ can be varied in time φₖ=φ₀+2π k/N and k=1,2, . . . ,N. Equation 7 can be written also as:

Ψ₀=σg₀+i 2 σg₁ sin(2πx/Λ+φₖ) (8)

Assuming that the object is transparent and affects the electromagnetic wave by phase shifts related to the variations of refraction index within the object, the phase shifts can be modeled by a complex function Θ(x):

$$Θ ( x ) = {\int }_{ξ = 0}^{∞} exp [ i M ( ξ ) sin ( 2 π ξ x + φ ( ξ ) ) ] d ( ξ ) \qquad ( 9 )$$

Where ξ is a spatial frequency and M(ξ), φ(ξ) are the modulation and phase. It is assumed that the phase shifts created by the object are small (small disturbance assumption) and can use the approximation:

exp[α sin(β)]˜=J₀(α)+J₁(α)exp[i β]−J₁(α)exp[−iβ] (10)

Where is J₀, J₁ are Bessel functions of 0 and 1 orders. θ(x) can now be written as:

$$Θ ( x ) = {a}_{0} + i {\int }_{ξ = 0}^{∞} 2 a ( ξ ) sin ( 2 π ξ x + φ ( ξ ) ) d ( ξ ) \qquad ( 11 )$$

And the small disturbance assumption means that:

$${‖ {a}_{0} ‖}^{2} ≫ {‖ {\int }_{ξ = 0}^{∞} i a ( ξ ) sin [ ( 2 π ξ x + φ ( ξ ) ) ] d ( ξ ) ‖}^{2} \qquad ( 12 )$$

A real image of the object is projected to a detector 16 (e.g a sensor such as a camera etc.). The detector records multiple images of the object where each image is recorded with the periodic pattern illumination in a different location/phase of the pattern. A processor 17 calculates a synthetic image of the object by using the transformation of Equation 6, reduced to one axis, to extract the component S′₂ 90 degrees out of phase with the phase modulated electromagnetic wave illumination of the object.

### Goal:

The goal of the analysis is to prove that the intensity signal detected at the image plane by detector 16 can be analyzed by processor 17 using the transformation of Equation 6, to extract the component S′₂ 90 degrees out of phase with the illumination pattern and that component S′₂ is related to the object as the Hilbert transform of the phase shifts Θ(x), induced by the object, within a band of spatial frequencies ξ=0−Max. The aforementioned can be translated into mathematical form of:

$${S}_{2}^{′} = {\int }_{ξ = 0}^{Max} T ( ξ ) a ( ξ ) cos ( 2 π ξ x + φ ( ξ ) ) d ( ξ ) \qquad ( 13 )$$

Where T(ξ) is the transfer function of the imaging system.

### Proof:

The electromagnetic wave function, after passing through the object 14, can be expressed in the form of:

Ψ′₁=Ψ₀Θ (14)

And using equation 5 in exponential form, receive:

$${Ψ}_{1}^{′} = σ {g}_{0} {a}_{0} + σ {g}_{1} {a}_{0} \{ exp [ i ( 2 π x \text{/} Λ + {φ}_{k} ) ] - exp [ - i ( 2 π x \text{/} Λ + {φ}_{k} ) ] \} ++ σ {g}_{0} {\int }_{ξ = 0}^{∞} a ( ξ ) \{ exp [ i ( 2 π ξ x + φ ( ξ ) ] - exp [ - i ( 2 π ξ x + φ ( ξ ) ] \} d ( ξ ) ++ σ {g}_{1} {\int }_{ξ = 0}^{∞} a ( ξ ) \{ exp [ i ( 2 π ξ x + φ ( ξ ) + 2 π x \text{/} Λ + {φ}_{k} ) ] + exp [ - i ( 2 π ξ x + φ ( ξ ) + 2 π x \text{/} Λ + {φ}_{k} ) ] \} d ( ξ ) + σ {g}_{1} {\int }_{ξ = 0}^{∞} a ( ξ ) \{ - exp [ i ( 2 π ξ x + φ ( ξ ) - 2 π x \text{/} Λ - {φ}_{k} ) ] - exp [ - i ( 2 π ξ x + φ ( ξ ) - 2 π x \text{/} Λ - {φ}_{k} ) ] \} d ( ξ ) \qquad ( 15 )$$

An optical imaging system 15 in FIG. 2 is represented, for the purpose of the analysis, by a classical model of coherent transfer function H(ξ) with unit transmission up to a cut off frequency defined by the numerical aperture of the lens system. For simplicity it is further assumed that the illumination is designed such that the basic period Λ also defines the cut off frequency:

$$H ( ξ ) = \{ \begin{matrix}1 & \vert ξ \vert < 1 \text{/} Λ \\ 0 & \vert ξ \vert >= 1 \text{/} Λ\end{matrix} \qquad ( 16 )$$

Using the optical transfer function H(ξ) the wave function can be analyzed at the image plane Ψ₁ by filtering out all spatial frequencies higher than 1/Λ resulting in:

$${Ψ}_{1} ( x , k ) = σ {g}_{0} {a}_{0} + i 2 σ {g}_{1} {a}_{0} sin ( 2 π x \text{/} Λ + {φ}_{k} ) ++ i2 σ {g}_{0} {\int }_{ξ = 0}^{1 / Λ} a ( ξ ) sin ( 2 π ξ x + φ ( ξ ) ) d ( ξ ) ++ 2 σ {g}_{1} cos ( 2 π x \text{/} Λ + {φ}_{k} ) {\int }_{ξ = 0}^{2 / Λ} - a ( ξ ) cos ( 2 π ξ x + φ ( ξ ) ) d ( ξ ) + 2 σ {g}_{1} sin ( 2 π x \text{/} Λ + {φ}_{k} ) {\int }_{ξ = 0}^{2 / Λ} - a ( ξ ) sin ( 2 π ξ x + φ ( ξ ) ) d ( ξ ) \qquad ( 17 )$$

And the intensity at the image plane measured by detector 16 is equal to:

Iₖ=∥Ψ₁(x,k)|² (18)

Components whose contribution to the energy is very small can be neglected using the assumption of small disturbance in Expression 12 and get:

$${I}_{k} ∼ = {( {Lg}_{0} {a}_{0} )}^{2} + 4 {( σ {g}_{1} {a}_{0} )}^{2} {sin}^{2} ( 2 π x \text{/} Λ + {φ}_{k} ) + 2 {σ}^{2} {g}_{0} {a}_{0} {g}_{1} cos ( 2 π x \text{/} Λ + {φ}_{k} ) {\int }_{ξ = 0}^{2 / Λ} - a ( ξ ) cos ( 2 π ξ x + φ ( ξ ) ) d ( ξ ) + 2 {σ}^{2} {g}_{0} {a}_{0} {g}_{1} sin ( 2 π x \text{/} Λ + {φ}_{k} ) {\int }_{ξ = 0}^{2 / Λ} - a ( ξ ) sin ( 2 π ξ x + φ ( ξ ) ) d ( ξ ) + 4 {σ}^{2} {g}_{0} {a}_{0} {g}_{1} sin ( 2 π x \text{/} Λ + {φ}_{k} ) {\int }_{ξ = 0}^{1 / Λ} a ( ξ ) sin ( 2 π ξ x + φ ( ξ ) ) d ( ξ ) \qquad ( 19 )$$

The component S₂ can be extracted from the measure intensity by the transformation of Equation 6 when reduced to one axis:

$${S}_{2}^{′} = {\sum }_{k = 1}^{N} {I}_{k} cos ( 2 π x \text{/} Λ + {φ}_{k} ) \qquad ( 20 )$$

And using the intensity according to equation 19, get:

$${S}_{2}^{′} = C {\int }_{ξ = 0}^{2 / Λ} a ( ξ ) cos ( 2 π ξ x + φ ( ξ ) ) d ( ξ ) \qquad ( 21 )$$

### Equation 13 is Therefore Proven.

Notice that to perform the transformation of Equation 20, a calibration step is required, in which the initial phases 2πx/Λ+φ₀ are be measured at each point of the image. This calibration is obvious for Intensity structured illumination because the grating can be seen and the phase of the grating analyzed from the intensity image of the camera, for example, when the object is a flat mirror. Calibration for phase grating is more complicated because the lines of phase do not appear in the intensity image. Note however, that the intensity image Iₖ is modulated with the second harmonic of the grating at the spatial frequency 2/Λ twice higher than the grating frequency at 1/Λ, thereby providing a simple method to calibrate the initial phase using the transformation:

$$Q = {\sum }_{k = 1}^{N} {I}_{k} exp [ i 4 π k \text{/} N ] \qquad ( 21 a )$$

and then the phase can be measured using:

2πx/Λ+φ₀=−0.5 arg{Q} (21b)

where arg{Q} is the argument of Q. The same concept can be applied for calibrating two dimensional grating in two axes x-y.

The transfer function T(ξ) of equation 13 is the constant C of Equation 21 and reaches a cut off frequency equal to 2/Λ, which is twice as high as the cut off frequency of the optical imaging system 15 at 1/Λ, as expressed in equation 16. The implication is an improvement of the lateral resolution two times higher (lateral super resolution) than previously achieved.

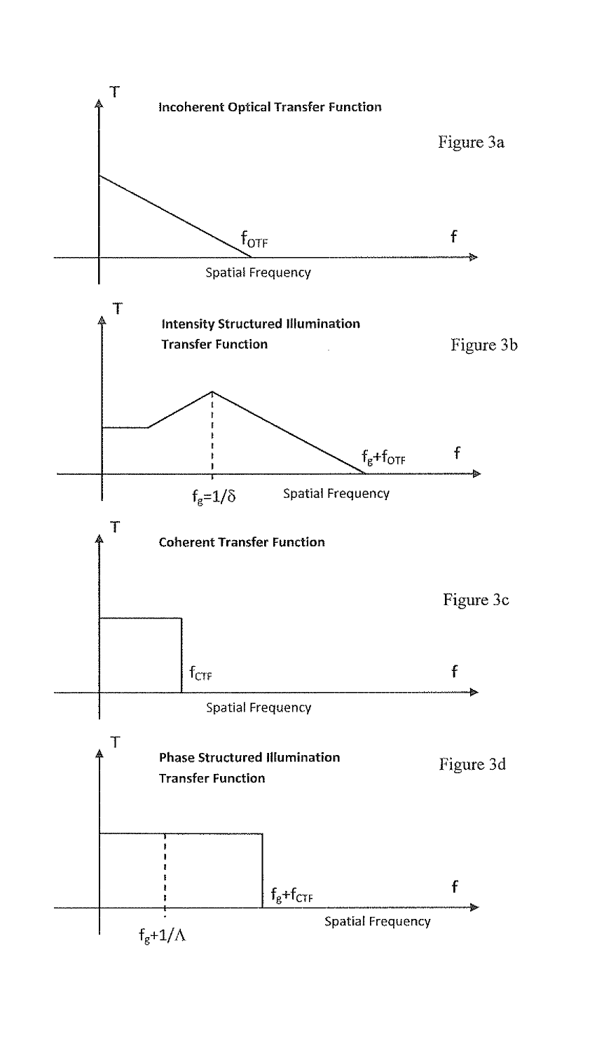

FIGS. 3a-3d depict various Transfer Functions. FIG. 3d shows the Transfer Function of a Phase Structured Illumination imaging apparatus as described by Equation 21, compared to the diffraction limited, aberration free Coherent Transfer Function in FIG. 3c as described by Equation 16. FIG. 3a depicts a diffraction limited, aberration free incoherent Optical Transfer Function. FIG. 3b depicts the Transfer Function of an intensity (amplitude) Structured Illumination imaging system as described in U.S. Pat. No. 5,867,604.

While the invention has been described with respect to a limited number of embodiments, it will be appreciated that many variations, modifications and other applications of the invention may be made. Therefore, the claimed invention as recited in the claims that follow is not limited to the embodiments described herein.

### REFERENCE

1. Zernike, F. (1955). “How I Discovered Phase Contrast”. Science 121 (3141): 345-349.
2. Georges, Nomarski (1960), “Interferential polarizing device for study of phase objects”, U.S. Pat. No. 2,924,142
3. Minsky, M (1961), “Microscopy apparatus”, U.S. Pat. No. 3,033,467
4. Dailey M., Manders E., Soil D., Terasaki M., Confocal Microscopy of Living Cells, Chapter 19 Handbook of Biological Confocal Microscopy 3^{rd} edition, Springer 2006
5. Heintzmann, R., Structured Illumination Methods, Chapter 13 Handbook of Biological Confocal Microscopy 3^{rd} edition, Springer 2006
6. Lukosz W., Lukosz 1967, Optical systems with resolving powers exceeding the classical limit. II, J. Opt. Soc. Am. 57:932-941.
7. Ben-Levy, M., and Peleg, E., (1995), Imaging measurement system, WO 97/06509, U.S. Pat. No. 5,867,604.
8. Gabriel Popescu, “Diffraction phase microscopy for quantifying cell structure and dynamics”, Mar. 15, 2006/Vol. 31, No. 6/OPTICS LETTERS
9. Takahiro Ikeda, “Hilbert phase microscopy for investigating fast dynamics in transparent systems”, May 15, 2005/Vol. 30, No. 10/OPTICS LETTERS
10. Gabriel Popescu , “Diffraction Phase Microscopy with White Light”, United States Patent Application US20140085715, filed Feb. 25, 2013
11. Shwetadwip Chowdhuryand Joseph Izatt, “Structured illumination diffraction phase microscopy for broadband, subdiffraction resolution, quantitative phase imaging”, Feb. 15, 2014/Vol. 39, No. 4/OPTICS LETTERS

What is claimed is:

1. An imaging apparatus for imaging objects, comprising:
(a) an object plane and an image plane;
(b) a first grating, said first grating being an intensity grating adapted to modulate the intensity of an electromagnetic wave in a periodic pattern, forming an intensity modulated electromagnetic wave;
(c) a first optical imaging system, said first optical imaging system adapted to project a first real image of said intensity modulated electromagnetic wave at said first grating to said object plane;
(d) a second grating, said second grating being a two dimensional phase grating adapted to modulate the phase of an electromagnetic wave in a periodic pattern, forming a phase modulated electromagnetic wave;
(e) a second optical imaging system, said second optical imaging system adapted to project a second real image of said phase modulated electromagnetic wave at said second grating to said object plane, in a direction opposite to a direction of said light projected by said first optical imaging system;
(f) a third optical imaging system adapted to image light at said object plane to said image plane,
said third optical imaging system adapted to image light traveling backwards from an object located at said object plane when illuminated by said first optical imaging system and light transmitted through said object when illuminated by said second optical imaging system;
(g) a sensor located at said image plane, said sensor adapted to capture said light imaged by said third optical imaging system; and
(h) a processor coupled to said sensor, said processor configured to calculate a first synthetic image of said object interacting with said electromagnetic wave projected by said first optical imaging system; and
said processor further configured to calculate a second synthetic image of said object interacting in phase shifts with said electromagnetic wave projected by said second optical imaging system at said object.

2. The imaging apparatus of claim 1, wherein said processor is further configured to combine said first synthetic image and said second synthetic image to obtain images of electromagnetic phase shifting by said object and electromagnetic interactions other than phase shifting with said object.

3. The imaging apparatus of claim 1, wherein said processor is further configured to combine said first synthetic image and said second synthetic image to obtain images of florescence labels and phase shifting of said object.

4. The imaging apparatus of claim 1, wherein said processor is further configured to combine said first synthetic image and said second synthetic image to obtain images of luminescent labels and phase shifting objects.

5. The imaging apparatus of claim 1, wherein said processor is further configured to combine said first synthetic image and said second synthetic image to obtain images of Raman scattering and phase shifting objects.

6. The imaging apparatus of claim 1, wherein said processor is further configured to calculate a third synthetic image by extracting a signal 90 degrees out of phase with said intensity modulated electromagnetic wave.

7. The imaging apparatus of claim 1, wherein said periodic pattern of said first grating is displaced in time to vary a pattern phase.

8. The imaging apparatus of claim 1, wherein said periodic pattern of said second grating is displaced in time to vary a pattern phase.

9. The imaging apparatus of claim 1, wherein said periodic pattern of said first grating and said period pattern of said second grating are displaced by a single actuator.

10. The imaging apparatus of claim 1, wherein said calculation of said first synthetic image is executed by extracting a signal in phase with said intensity modulated electromagnetic wave and said calculation of said second synthetic image is executed by extracting a signal 90 degrees out of phase with said phase modulated electromagnetic wave.

11. A method for imaging a live cell object, the method comprising the steps of:
(a) modulating the phase of an electromagnetic wave in a periodic pattern with a two dimensional phase grating to produce a phase modulated electromagnetic wave in two axes;
(b) projecting a real image of said phase grating onto an object to produce phase modulated electromagnetic wave illumination of said object;
(c) varying a location of said periodic pattern in time along said two axes to change the phase of said periodic pattern;
(d) projecting a real image of said object to a detector;
(e) recording multiple images of said object with said detector, each of said images is recorded with said periodic pattern in a different said location; and
(f) calculating a synthetic image of said object by extracting information 90 degrees out of phase with said illumination.
